(19) United States
(12) Patent Application Publication
(10) Pub. No.: US 2011/0151127 A1
(43) Pub. Date: Jun. 23, 2011

(54) NOVEL MIXTURES OF POLYISOCYANATE COMPOSITIONS

(76) Inventors: Jean-Marie Bernard, Saint-Larent d'Agny (FR); Philippe Olier, Lyon (FR)

(21) Appl. No.: 12/995,864

(22) PCT Filed: Jun. 3, 2009
(86) PCT No.: PCT/FR2009/051047

§ 371 Date: Mar. 2, 2011

(30) Foreign Application Priority Data
Jun. 3, 2008 (FR) 0853671

(51) Int. Cl. B05D 3/02; C09D 175/04; C09D 163/00

(52) U.S. Cl. 427/385.5; 524/872; 523/400

(57) ABSTRACT

The present invention concerns a composition of polyisocyanates comprising a composition of hydrophilic polyisocyanates consisting of at least one hydrophilic (poly)isocyanate, comprising an isocyanate part and a hydrophilic group, said hydrophilic group being of monofunctional polyoxyalkylene type and being attached to the isocyanate part via a function containing a chain of formula

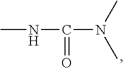

and a composition of polyisocyanates consisting of a composition consisting of a mixture of at least one (poly)isocyanate with at least one compound having an ionic function, said mixture being characterized in that it comprises 2% to 15% of said compound and 50% to 98% of (poly)isocyanate.

The subject of the present invention concerns novel mixtures of polyisocyanate compositions, notably comprising a composition of hydrophilic polyisocyanates, and their use for the preparation of coatings, in particular paints or varnishes.

The fields of application in which coatings are used are highly diverse and increasingly require coating compositions of very high technicality, having excellent qualities both with respect to application of the coating and to the characteristics of the end product.

In the wood sector for example, particularly wood flooring, the application of a varnish is a necessary step to obtain protection and a pleasing appearance. Aliphatic isocyanates, through their intrinsic properties (resistance to ageing, chemical resistance, durability), are compounds of choice for this type of application. Legislation currently requests systems in these areas to contain increasingly fewer volatile organic compounds (150 g/L for example for wood flooring). In particular, aqueous phase polyurethane dispersions (PUDs) are widely used and meet VOC criteria. However, they conventionally suffer from lack of performance in highly demanding applications. In this case, an isocyanate cross-linking agent is added to improve performance.

Having regard to the type of application (often without specific mixing equipment), the ease with which the two components can be mixed, (part A comprising the polyurethane dispersion and part B comprising the isocyanate cross-linking agent) is essential.

On specific constraint in the area of floor coverings lies in obtaining a very high shine (>80 to 60° after application. In this respect, the compounds used to date are hydrophilic compounds having a particular structure, namely hydrophilic trimer allophanates. These compounds have the disadvantage of having high molar mass and high viscosity and are therefore difficult to disperse.

The objective of the present invention is therefore to provide a particular mixture comprising hydrophilic polyisocyanates which are easy to mix, whilst maintaining satisfactory properties in terms of shine.

The present invention therefore concerns a composition of polyisocyanates comprising:
A) a composition of hydrophilic polyisocyanates, preferably non-ionic, consisting of at least one hydrophilic (poly)isocyanate, preferably non-ionic, comprising an isocyanate part and a hydrophilic group, said hydrophilic group being of monofunctional polyoxyalkylene type and attached to the isocyanate part via a function containing a chain of formula

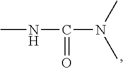

and
B) a composition of polyisocyanates consisting:
   a) either of a composition comprising a mixture of at least one (poly)isocyanate with at least one compound having an ionic function, preferably anionic, preferably carrying at least one monofunctional polyoxyalkylene chain, preferably polyoxyethylene, and preferably carrying a lipophilic part containing a hydrocarbon radical, said lipophilic part advantageously being an alkyl group comprising 1 to 30, preferably 1 to 20, carbon atoms,
      said mixture being characterized in that it comprises 2% to 15% of said compound and 50% to 98% of (poly)isocyanate,
   b) or of a composition comprising at least one (poly)isocyanate comprising at least one bonded ionic function, notably of sulfonate, carboxylate, phosphate or quaternary ammonium type and preferably a 2-(cyclohexylamino)-ethanesulfonate or 3-(cyclohexylamino)-propane sulfonate,
   c) or a composition consisting of a mixture of a composition (a) and a composition (b),
   d) or a composition consisting of at least one (poly)isocyanate comprising at least one urethane function carrying at least one monofunctional polyoxyalkylene chain, preferably polyoxyethylene, preferably monoalkyl, said alkyl group comprising 1 to 30, preferably 1 to 20, notably 1 to 6 carbon atoms, in association with a composition (a), (b) or (c).

The (poly)isocyanate compositions contained in the compositions of the present invention consist of any isocyanate and polyisocyanate, either alone or in a mixture with one or more other isocyanates and/or polyisocyanates. The term “(poly)isocyanate” is to be construed here as grouping together the terms “isocyanate” and “polyisocyanate”.

Preferably, these (poly)isocyanates are prepared from aliphatic, heterocyclic, cycloaliphatic, araliphatic and/or aromatic diisocyanates.

In composition (A) of the composition according to the invention, in the above-mentioned formula

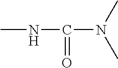

the terminal nitrogen atom comprises two arms which can be attached either to a hydrogen atom or to a carbon atom.

The chain of formula

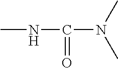

allows the isocyanate part to be attached
to at least one hydrophilic group of the polyisocyanate(s) of composition (A).

In composition (A) of the composition according to the invention, the above-mentioned formula

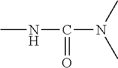

allows encompassing of the urea, allophanate, biuret
and acylurea functions, whilst excluding the urethane function.

### Effectively:

the urea function corresponds to formula

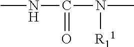

in which R₁¹ is a hydrogen atom or a hydrocarbon chain, preferably a C₁-C₂₀ alkyl group possibly also containing heteroatoms such as F, Si or O in particular;
the allophanate function corresponds to formula

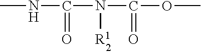

in which R₂¹ represents either a hydrogen atom, or a hydrocarbon chain, preferably a C₁-C₂₀, alkyl group possibly also containing heteroatoms such as F, Si or O in particular, or a hydrophilic group, or a group comprising at least one isocyanate function; (the hydrophilic group can effectively bind to the isocyanate part via group R₂¹ or via the terminal oxygen atom).
the biuret function corresponds to formula

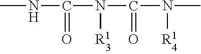

in which R₃¹ and R₄¹ each independently represent either a hydrogen atom, or a hydrocarbon chain, preferably a C₁-C₂₀ alkyl group possibly also containing heteroatoms such as F, Si or O in particular, or a hydrophilic group, or a group comprising at least one isocyanate function;
and the acylurea function corresponds to formula

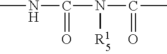

in which R₅¹ represents either a hydrogen atom, or a hydrocarbon chain, preferably a C₁-C₂₀ alkyl group possibly also containing heteroatoms such as F, Si or O in particular, or a hydrophilic group, or a group comprising at least one isocyanate function.

When the above-mentioned chain corresponds to a urea function, the linking between the isocyanate part and the hydrophilic group occurs at the nitrogen atom carrying the above-mentioned R₁¹ group.

When the above-mentioned chain corresponds to an allophanate function, the linking between the isocyanate part and the hydrophilic group occurs either at the oxygen atom of the terminal COO group or at the nitrogen atom carrying the above-mentioned R₂¹ group.

When the above-mentioned chain corresponds to the biuret function, the linking between the isocyanate part and the hydrophilic group takes place either at the nitrogen atom carrying the above-mentioned R₄¹ group or at the nitrogen atom carrying the above-mentioned R₃¹ group.

When the above-mentioned chain corresponds to an acylurea function, the linking between the isocyanate part and the hydrophilic group takes place either at the carbon atom of the terminal CO terminal group or at the nitrogen atom carrying the above-mentioned R₅¹ group.

Provision may also be made so that the (poly)isocyanates of above-mentioned composition (A) comprise a mixture of the above-mentioned functions (urea, acylurea, allophanate or biuret), i.e. composition (A) can comprise different polyisocyanates in which the isocyanate part is attached to the hydrophilic group by different functions. Similarly, composition (A) may comprise different polyisocyanates comprising several hydrophilic groups which may be attached to the isocyanate part via different functions.

Preferably, the polyisocyanate(s) of composition (A) are characterized in that the ratio between the number of moles of allophanate functions carrying at least one hydrophilic group and the number of moles of urethane functions carrying at least one hydrophilic group is greater than 1, and notably greater than 2.

When the function linking the isocyanate part to the hydrophilic group of composition (A) is an allophanate function, the preferred compositions (A) are notably those described in U.S. Pat. No. 6,426,414.

The compounds comprising a urea function as mentioned above are notably obtained by the reaction of isocyanate compounds with an ethoxylated amine.

The compounds comprising an acylurea function as mentioned above are notably obtained by reaction of isocyanate compounds with an amide (itself being obtained for example by reaction of an ethoxylated amine with an anhydride function).

The compounds comprising a biuret function as mentioned above are notably obtained by the reaction of isocyanate compounds with a urea function comprising an ethoxylated group.

Preferably, the above-mentioned ethoxylated amines are monoethoxylated amines meeting formula (G) mentioned below. Among these amines, particular mention may be made of Jeffamine® XTJ 581.

In composition (a), the compound having an ionic function is notably a surfactant. In this respect, reference can be made to international application WO 97/31960 which describes compositions of type (a). Preferably, in composition (a) such as defined above, the weight ratio between the compound having an ionic function and the (poly)isocyanate lies between 3 to 30%, preferably 5 to 25%, and advantageously 5 to 20%. With these values it is possible to obtain an emulsion adapted to the various envisaged applications.

Advantageously, composition (a) may further contain a solvent, the quantity of solvent relative to the quantity of mixture formed by the surfactant system and the (poly)isocyanate being less than 50 weight %, preferably less than 40 weight %, the solvent being chosen from the group consisting of esters, ethers, des acetals, cyclic or linear carbonates, lactones, glycol ethers or propylene glycol ethers and N-alkyl-amides.

The solvent is used in this embodiment to reduce the viscosity of the starting polyisocyanates.

This content of solvent is notably necessary to apply compounds such as IPDT which are solid at ambient temperature and are used in the form of formulations.

The solvent content is minimized to avoid having compositions too high in VOCs (volatile organic compounds).

Advantageously, the compound having an ionic function in composition (a) is chosen to that it contains no or very little reactive function with the (poly)isocyanate. In other words, said compound having an ionic function is present in composition (a) in essentially free form (as opposed to a form linked via a chemical bond with the (poly)isocyanate).

The expression “essentially free form” means that less than 50%, advantageously less than 20%, preferably less than 10% by weight of the compound having an ionic function is in bonded form.

According to another embodiment, above-mentioned composition (B) can consist of a composition (a′) consisting of at least one (poly)isocyanate and at least one surfactant comprising an amine and a compound meeting one of the following formulas (I′) and (II′):

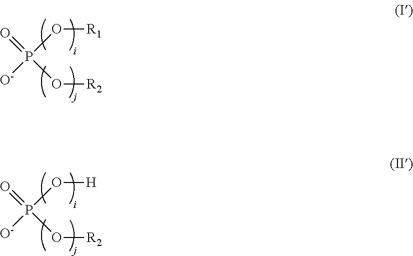

in which:
   i and j each independently represent 0 or 1;
   R₁ and R₂, the same or different each independently represent a hydrocarbon chain, advantageously chosen from among C₆-C₃₀ aryl groups and C₁-C₂₀ alkyl groups, optionally substituted, advantageously C₄-C₁₀ alkyl groups optionally substituted by at least one halogen, notably a fluorine.

According to another embodiment, above-mentioned composition (B) may consist of a composition (a′) consisting of at least one (poly)isocyanate and at least one surfactant comprising an amine and a mixture of compounds meeting following formulas (I′) and (II′):

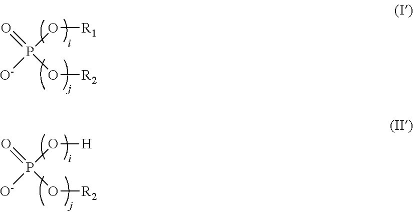

in which:
   i and j each independently represent 0 or 1;
   R₁ and R₂, the same or different, each independently represent a hydrocarbon chain, advantageously chosen from among C₆-C₃₀ aryl groups and C₁-C₂₀ alkyl groups, optionally substituted, advantageously C₄-C₁₀ alkyl groups optionally substituted by at least one halogen, notably a fluorine;
      said mixture of compounds of formula (I′) and (II′) preferably being characterized in that the molar ratio between compound (II′), i.e. the compound of monoester type, and compound (I′), i.e. the compound of diester type, is greater than 1 and is preferably between 1 and 10, and is advantageously 2 to 6.

For example, in the surfactant of above-mentioned composition (a′), the amine is an amine of following formula (III′):

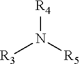

in which R₃, R₄ and R₅ each independently represent H or a hydrocarbon chain, advantageously chosen from among the C₆-C₃₀ aryl groups and the C₁-C₂₀ alkyl groups, optionally substituted, notably by at least one halogen, notably a fluorine, said alkyl groups possibly being cyclic, linear or branched.
the R₃, R₄ and R₅ groups possibly comprising at least one alkylene oxide group, preferably at least one ethylene oxide group.

It is also possible that the R₃, R₄ and R₅ groups may form cycles between them. For example R₃ and R₄ or R₄ and R₅ or R₃ and R₅ may together form a cycle preferably consisting of 3 to 5 carbon atoms, and optionally containing at least one heteroatom preferably chosen from among oxygen or sulphur. Among these cycles, mention may be made of: N-ethyl morpholine, N-methyl morpholine and 1,2,2,6,6-pentamethylpipéridine.

Advantageously, in above-mentioned formula (III′), R₃, R₄ and R₅ each independently represent a C₆⁻C₃₀ aryl group or a C₁-C₂₀ alkyl group.

This embodiment corresponds to hydrophobic amines. Said amines do not therefore contain any akylene oxide group.

According to another advantageous embodiment, the composition such as defined above comprises an amine of formule (III′) in which at least one of groups R₃, R₄ and R₅ comprises at least one alkylene oxide group, and preferably at least one ethylene oxide group. Preferably, composition (A) is different from composition (b).

The preferred polyisocyanates of composition (b), namely the (poly)isocyanates comprising at least one bonded 2-(cyclohexylamino)-ethanesulfonate or 3-(cyclohexylamino)-propanesulfonate function, are notably described in U.S. Pat. No. 6,767,958.

Therefore the composition of the present invention may also consist of a ternary mixture, namely a composition comprising a composition (A) and a composition (c), composition (c) consisting of a mixture of a composition (a) and a composition (b).

The composition of polyisocyanates according to the present invention such as defined above, can therefore be obtained by mixing:
A) a composition of hydrophilic polyisocyanates consisting of at least one hydrophilic (poly)isocyanate comprising a hydrophilic group of monofunctional polyoxyalkylene type attached to the isocyanate part via a function containing a chain of formula

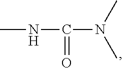

and
B) a composition of polyisocyanates consisting of:
   a) either a composition consisting of a mixture of at least one (poly)isocyanate with at least one compound having an ionic function carrying at least one monofunctional polyoxyalkylene chain, preferably polyoxyethylene,
      said mixture being characterized in that it comprises 2% to 15% of said compound and 50% to 98% of (poly)isocyanate,
   b) or a composition consisting of at least one (poly)isocyanate comprising at least one bonded ionic function, notably of sulfonate, carboxylate, phosphate or quaternary ammonium type and preferably a 2-(cyclohexylamino)-ethanesulfonate or 3-(cyclohexylamino)-propane sulfonate function,
   c) or a composition consisting of a mixture of a composition (a) and a composition (b),
   d) or a composition consisting of at least one (poly)isocyanate comprising at least one urethane function carrying at least one monofunctional polyoxyalkylene chain, preferably polyoxyethylene, in association with a composition (a), (b) or (c).

Preferably, the composition of polyisocyanates (A) such as defined above has:
a mean NCO functionality of at least 2, and preferably 2.2 to 6,
a content of NCO isocyanate groups of 5% to 25% by weight, and,
a content of ethylene oxide units of 2% to 50%, preferably 2% to 20%, and preferably 5% to 15% by weight, said ethylene oxide units being incorporated in polyether chains containing an average of 5 to 35 ethylene oxide units,
   said composition (A) being characterized in that at least 60% moles of polyether chains are attached via urea or allophanate or biuret or acylurea groups to two molecules of diisocyanates or polyisocyanates, notably prepared from at least two molecules of diisocyanates.

The preferred compositions (A) notably comprise Bayer products of Bayhydur® type such as Bayhydur® 304 (or VP LS 2319) or Bayhydur® 305 (or VP LS 2336). Preferably, composition (A) comprises Bayhydur® 305 (or VP LS 2336).

Under the present invention, the mean isocyanate functionality f(iNCO) is defined by the following formula:

$$f ( iNCO ) = \frac{Mn \times [ iNCO ]}{42 \times 100}$$

where: Mn represents the number average molecular weight obtained by gel permeation, and
   [iNCO] represents the concentration of isocyanate functions in grams per 100 grams.

Preferably, the composition of polyisocyanates (b) such as defined above has:
a mean NCO functionality of at least 2 and preferably 2.2 to 6;
a content of isocyanate NCO groups of 5% to 25% by weight;
a mole content of ionic functions, preferably SO₃⁻ functions per 100 g of composition (b) of between 10⁻⁵ to 1, preferably from 10⁻⁴ to 0.5;
a content of ethylene oxide units of 0% to 19.5%, preferably 0% to 17%, by weight, said ethylene oxide units being incorporated in polyether chains containing a mean of 5 to 55, preferably 7 to 30 ethylene oxide units.

According to one advantageous embodiment, the (poly)isocyanate comprising at least one urethane function carrying at least one monofunctional polyoxyalkylene chain of composition (d) has:
a mean NCO functionality of at least 2, and preferably 2.2 to 6;
a content of isocyanate NCO groups of 5% to 25% by weight, and
a content of ethylene oxide units of 2% to 50%, preferably 2% to 20% and preferably 5% to 15% by weight, said ethylene oxide units being incorporated in polyether chains containing a mean of 5 to 35 ethylene oxide units.

According to another advantageous embodiment, the present invention concerns a composition of polyisocyanates such as defined above in which composition (B) consists of a composition (a) such as defined above.

Said composition therefore corresponds to a mixture of a composition (A) and of a composition notably of Rhodocoat® type.

Preferably, said composition comprises:
20% to 80%, and preferably 25% to 50% by weight of composition (A), and
20% to 80%, preferably 50% to 75% by weight of composition (a).

According to another embodiment, composition (a) such as defined above is characterized in that the compound having an ionic function is a surfactant comprising:
(i) at least one acid or mixture of acids, and
(ii) at least one amine or polyamine or a mixture of these amines, optionally heterocyclic, said amine carrying at least one alkylene oxide function, preferably ethylene oxide.

The amine forming the surfactant may be a heterocyclic amine, said heterocycle possibly containing at least one other heteroatom. Under the present invention, when the amine of the surfactant is a heterocyclic amine, the alkylene oxide function is preferably carried by the nitrogen atom of the amine function.

The above-mentioned amine may contain several alkylene oxide functions, the same of different, and these different functions may be in blocks or alternate.

The term “polyamine” designates a compound having at least 2 amine functions. Among the polyamines, particular mention may be made of the polyetheramines Elastamine® (Huntsman) or Jeffamine® (Huntsman), and more particularly the following products:
RP-409 (or XTJ-582) of molecular weight of about 400, and RP-2009 (or XTJ-578) of molecular weight of about 2 000, whose backbone is the following:

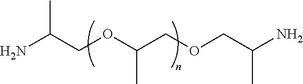

RTP-1006 (or XTJ-542) and RTP-1407 (or XTJ-559) with the following poly(tetramethylene ether)glycol (PTMEG) backbone:

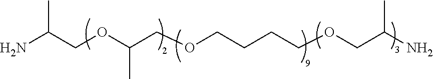

RE-600 (or XTJ-500), RE-900 (XTJ-501) or RE-2000 (or XTJ-502) with the following PEG, backbone:

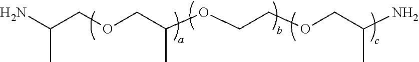

RTP-2007, RTP-2005, RTP-1006 and RTP-1407 of following formula:

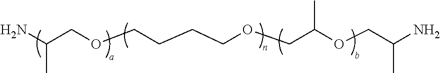

| | | | | | Moles of |
|---|---|---|---|---|---|
| | Molecular | | | | propylene oxide |
| Designation | weight | n | a | b | (PO) |
| RTP-2007 (or | 2 000 | 9 | 12 | 11 | 24 |
| XTJ-533) | | | | | |
| RTP-2005 (or | 2 000 | 14 | 9 | 8 | 18 |
| XTJ-536) | | | | | |
| RTP-1006 (or | 1 000 | 9 | 3 | 2 | 6 |
| XTJ-542) | | | | | |
| RTP-1407 (or | 1 350 | 14 | 3 | 2 | 6 |
| XTJ-559) | | | | | |

HT-1700 (or XTJ-548) of following formula:

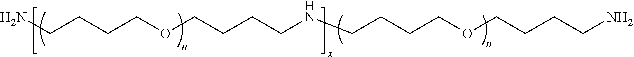

where n=13 and x=0-2
HE-150 (or XTJ-504):

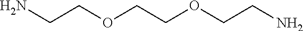

HE-180 (or XTJ-590):

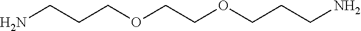

HE-1000 (PEG type):

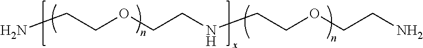

where n=13 and x=0-1

The following compounds of the HT series can also be cited:

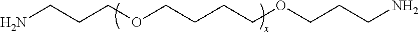

and the compounds of series HP-2000 (bis(aminopropyl) PEA):

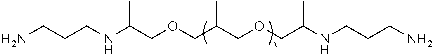

Among the polyamines, mention may also be made of the compound XTJ-616 (tetrafunctional amine containing propylene oxide) with molecular weight of about 600:

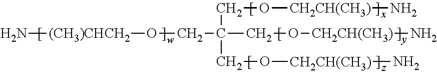

or the compounds XTJ-523 or XTJ-527 (butylene oxide backbone):

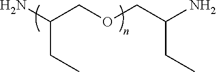

According to one particular embodiment, the above-mentioned surfactant of composition (a) comprises at least one acid or mixture of acids, and at least one amine carrying a polyoxyalkyléne chain, preferably polyoxyethylene.

According to one embodiment, the surfactant may be in salt form.

According to another embodiment, the above-mentioned surfactant of composition (a) comprises at least one acid carrying at least one —X—H, X group being chosen from among the elements in the columns of oxygen, nitrogen, carbon.

According to a further embodiment, said surfactant of said composition (a) comprises at least one acid whose pKₐ in water is lower than 5, preferably lower than 4, and advantageously lower than 3.

Preferably, in the surfactant of composition (a) such as defined above, the molar ratio between the sum of the acid functions and the sum of the amine functions lies between 0.5 to 2.5, advantageously from 0.7 to 1.5, and preferably from 1 to 1.2.

Under the present invention, it is not compulsory to neutralize all the acid functions by the amines.

With said ratio, it is possible to modify the type of surfactant system making it hydrophilic to a greater or lesser extent according to the levels of ionic functions. It also allows secondary reactions to be limited, which may occur between the isocyanate groups and the acid functions when the ratio is higher than 1.

According to one particular embodiment, the composition (a) such as defined above may comprise at least one amine such as defined above, i.e. an amine carrying at least one alkylene oxide function, preferably ethylene oxide, and another amine which may be a primary amine and/or secondary and/or tertiary amine not containing any alkylene oxide fragment.

According to one preferred embodiment, the acid or at least one acid of the mixture of acids of the surfactant of composition (a) comprises at least one group Q chosen from the group comprising [—S—(O)₂]—NH—[—S—(O)₂]—, [—S—(O)₂]—NH—CO—, [—S—(O)₂]₃—CH—, [—S—(O)₂]₂—CH—C(═O)— and [—S—(O)₂]—CH[—C(═O)—]₂, said groups Q possibly being attached via the sulphur atom or via the carbon atom directly to at least one carbon chain comprising 1 to 20 carbon atoms and optionally containing at least one halogen atom, notably at least one fluorine atom, and optionally heteroatoms, this chain possibly being alkyl, aryl, aralkyl, cyclic, aromatic, heterocyclic, straight and/or branched.

According to one particularly advantageous embodiment, the compound having an ionic function of composition (a) is a surfactant comprising an acid of following formula (I):

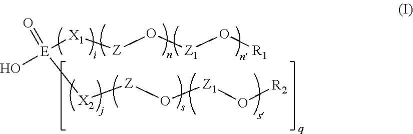

in which:
E represents phosphorus or carbon,
Z and Z₁ each independently represent a bivalent alkylene radical, straight or branched, consisting of 2 to 10, preferably 2 to 4 carbon atoms, Z and Z₁ possibly being the same or different, these alkylene units possibly being linked random fashion or in ordered blocks,
R₁ and R₂, the same or different, each independently represent a hydrocarbon chain, straight, branched or (hetero)cyclic, advantageously chosen from among the C₆-C₃₀ aryl groups and the C₁-C₃₀ alkyl groups, optionally substituted, advantageously C₄-C₁₆ alkyl groups and optionally substituted by at least one halogen, notably fluorine,
X₁ and X₂, the same or different, each independently represent S, O, N(R), R representing H, an alkyl group comprising 1 to 20 carbon atoms, a hydrocarbon bond or chain, optionally containing at least one heteroatom, preferably chosen from among oxygen or sulphur, attached to R₁ or R₂ to form a bivalent alkylene radical, straight or branched, optionally substituted, comprising 2 to 30 carbon atoms, said alkylene radical preferably being formed of 3 to 5 carbon atoms and optionally containing at least one heteroatom preferably chosen from among oxygen or sulphur or, when E represents a phosphorus atom, X₁ and/or X₂ may represent-O—[P(═O)-(A)]ᵥ-(O)ᵤ—, in which:
   A represents OH, —O—[(Z—O)ₙ—(Z₁—O)_{n′}]—R₁, [(Z—O)ₙ—(Z₁—O)_{n′}—]_{R}₁, —O—[(Z—O)ₛ—(Z₁—O)^{s′}]—R₂ or [—(Z—O)ₛ—(Z₁—O)_{s′}]—R₂2, Z, Z₁, R₁ and R₂ being such as defined above,
   v is an integer of between 1 to 6, and is preferably 1 or 2,
   u is an integer of 0 or 1,
i and j each independently represent 0 or 1;
n and n′ each independently represent zero or an integer of between 1 and 30;
q represents zero or 1; and
s and s′ each independently represent zero or an integer of between 1 and 30;
   on the understanding that when E is C, then q equals zero, and when E is C and X₁ is equal to the oxygen atom, then R₁ is advantageously different from H.

In formula (I), when E represents the phosphorus atom and X₁ represents a radical —O—[P(═O)-(A)]ᵥ-(O)ᵤ—, the compound of formula (I) belongs to the family of pyro-acids, such as the diesters, symmetrical or not, of pyrophosphoric acid.

When X₁ and/or X₂ represent a bond or alkylene radical, it is then possible to have a cyclic compound with nitrogen N in the cycle, this cycle possibly being attached to R₁ or R₂.

According to another embodiment, the above-mentioned acid of the surfactant of composition (a) meets following formula (II):

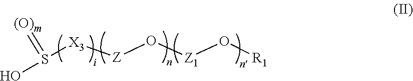

in which:
m is 1 or 2,
X₃ represents —O— or —NR—, R being as defined above for formula (I),
Z, Z₁, R₁, i, n and n′ being as defined above for formula (I).

According to a further embodiment, the above-mentioned acid of the surfactant of composition (a) is a combination of the structures presented above carried on one same molecule, which may be represented by following formula (III):

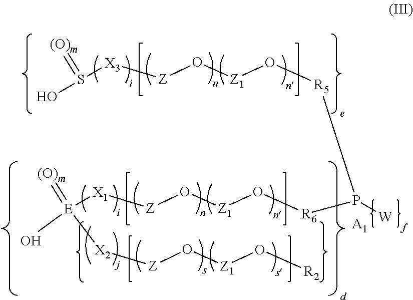

in which:
   A₁ represents the residue of a hydrocarbon molecule containing 1 to 100 carbon atoms and optionally containing at least one halogen atom, preferably at least one fluorine atom,
   d represents an integer from 0 to 10, preferably from 0 to 3,
   e represents an integer from 0 to 10, preferably from 0 to 3,
   f represents an integer from 0 to 10, preferably 0 to 3,
      the sum d+e+f lying between 2 and 10,
   W represents a hydrocarbon residue containing a Q group such as defined above,
   E represents a phosphorus or carbon atom,
   R₅ and R₆, each independently represent a bivalent alkylene radical, straight or branched, optionally substituted, containing 0 to 10 carbon atoms.

Advantageously, the abovementioned acid of the surfactant of composition (a) meets following formula (I-1):

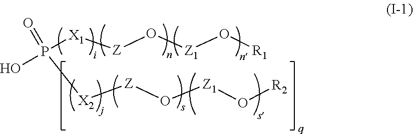

in which:
   i, j, n, n′, s, s′, q, Z, Z₁, R₁ and R₂ are such as defined above in formula (I),
   X₁ and X₂, the same or different, each independently represent —O— or —O—[P(═O)—(A)]ᵥ-(O)ᵤ—, A, u and v being such as defined above in formula (I).

Preferably, the surfactant of composition (a) comprises an acid of following formula (I-1):

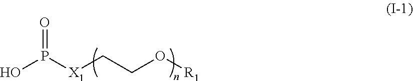

n, R₁ and X₁ being such as defined above in formula (I).

According to another advantageous embodiment, the acid of the surfactant of composition (a) meets following formula (I-3):

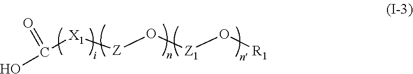

in which:
i, n, n′, Z and Z₁ and R₁ are such as defined above in formula (I),
X₁ represents O or N(R), R being such as defined above in formula (I).

Preferably, the surfactant of composition (a) such as defined above is chosen from the group comprising:
sulphonic acids such as para toluene sulphonic acid, dodecyl benzene sulphonic acid, naphtalene sulphonic acid, xylene sulphonic acid, camphorsulphonic acid, methane sulphonic acid, dodecane sulphonic acid, 3 sulpho propyl acrylate acid, 3 sulpho propyl methacrylate acid, trifluoromethane sulphonic acid, perfluorobutane sulphonic acid, sulphophtalic acid and perfluorooctane sulphonic acid;
sulphinic acids such as benzene sulphinic acid and para toluene sulphinic acid;
monoesters and diesters of alkyl phosphates such as dibutyl acid phosphate, di (2-ethylhexyl) acid phosphate, didodecyl acid phosphate, di (neodecanoyl) acid phosphate, monobutyl acid phosphate and monostearyl acid phosphate;
alkylphosphonic acids and the monoesters of alkylphosphonic acids such as methylphosphonic acid, octylphosphonic acid, hexadecamethylene phosphonic acid and 2 chloroethylphosphonic acid;
perfluoroacetic acids such as trifluoroacetic acid and hexafluoropropionic acid;
bis trifluoromethane sulphonimide;
triethylsulphonylmethane;
acid sulphates such as acid dodecasulphate or acid ether sulphates of monoalkyl ethers of polyethylene glycol, the alkyl ether being a hydrocarbon chain with 1 to 8 carbon atoms;
sulphamic acids such as cyclohexylsulphamic acid, butylsulphamic acid, N,N-dimethylsulphamic acid;
mono and diester phosphates of monoalkyl ethers of polyethylene glycol;
alkylene bis phosphonic acids such as methylene bisphosphonic acid or the esters of alkylene bis phosphonic acids;
naphtalene trisulphonic acid; and
sulphobenzoic acid.

Under the present invention, said acid may optionally be obtained by a precursor of an acid compound such as an acid anhydride or chloride.

Under the present invention, the amine of the surfactant of composition (a) may also be in salt form.

Composition (a) such as defined above preferably comprises a surfactant comprising an amine meeting following formula (IV):

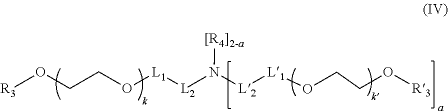

in which:
   a is 0, 1 or 2;
   R₄ represents a hydrogen atom or a hydrocarbon chain, straight or branched, advantageously chosen from among the C₁-C₂₀ alkyl groups, cyclic or not, and preferably from among the C₁-C₄ alkyl groups, or from among the aryl groups comprising 6 to 30 carbon atoms; and when a=0, the R₄ groups may be the same or different and may optionally together form a cycle comprising 2 to 20 carbon atoms, preferably 4 to 6 carbon atoms;
   R₃ and R′₃, the same or different represent a hydrogen atom or a hydrocarbon chain, straight or branched or (hetero)cyclic optionally substituted, advantageously chosen from among the C₁-C₂₀ alkyl groups, preferably from the C₁-C₄ alkyl groups or from the aryl groups comprising 6 to 30 carbon atoms;
   k represents an integer equal to or greater than 1, preferably equal to or greater than 2, advantageously between 5 and 60, and preferably from 5 to 40;
   k′ represents an integer advantageously of 0 to 60, and preferably of 5 to 40;
   L₁ and L′₁, the same or different, each independently represent a radical of formula-[-L′-O-]ₜ—, t representing an integer of between 0 to 20, and L′ representing an alkylene radical, straight or branched, comprising 3 to 10 carbon atoms, L′ preferably representing a radical-CH(CH₃)—CH₂— or —(CH₂)₄—, the groups t L′ possibly being the same or different;
   L₂ and L′₂, the same of different, each independently represent a bivalent alkylene radical, straight or branched, advantageously comprising 1 to 20 carbon atoms and preferably representing a radical —CH(CH₃)—CH₂—, —CH₂—CH(CH₃)— or —(CH₂)₄—.

According to another embodiment, the surfactant of composition (a) comprises a polyamine of following formula (V):

(R₄)₍₂₋ₐ₎-(D)ₐ-N-[L₂-L₁-(O—Z)ₖ—O-L′₁-L′₂-N(-D)]_{g}-L₂-L₁-(O—Z)ₖ-O-L′₁-L′₂-N-(D)ₐ-(R₄)₍₂₋ₐ₎ (V)
in which:
   D represents H or R₃—(O—Z)ₖ—O—L₁-L₂- or R₄,
   Z represents an alkylene residue, optionally substituted, comprising 2 to 6 carbon atoms, Z preferably being an ethylene group,
   g represents an integer of between 0 to 5, preferably 0 to 2,
   a, k, R₃, R₄, L₁, L₂, L′₁ and L′₂ being such as defined above for formula (IV).

Preferably, the amine of the surfactant of composition (a) according to the present invention meets following formula (G):

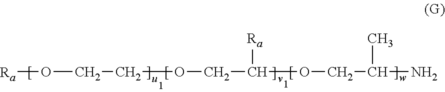

in which:
* u₁ represents an integer, preferably equal to or greater than 2, advantageously of 5 to 60, preferably 5 to 40;
v₁ represents an integer of between 0 to 30, preferably 0 to 10,
w represents an integer of between 1 to 30, preferably 1 to 10,
Rₐ represents an alkyl group comprising 1 to 20 carbon atoms, notably a methyl group or an alkyl group comprising 12 to 14 carbon atoms, all the Rₐ groups possibly being the same or different.

The preferred amines of composition (a) under the present invention are the following:
an amine of formula (G) in which v₁ is different from 0, Rₐ represents a C₁₂-C₁₄ alkyl radical with an ethylene oxide/propylene oxide ratio (u₁/w) of 9:2 (this amine is called Jeffamine® XTJ 247 and has a molecular weight of about 700); or
an amine of formula (G) in which v₁ is different from 0, Rₐ represents a methyl group with an ethylene oxide/propylene oxide ratio (u₁/w) of 12:2 (this amine is called Jeffamine® XTJ 581 and has a molecular weight of about 730).

The present invention concerns a composition such as defined above, in which the surfactant of composition (a) comprises:
at least one acid meeting following formula (I-1-1):

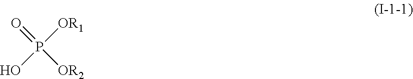

R₁ and R₂ being such as defined above in formula (I),
   and at least one amine meets formula (G) such as defined above in which v₁=0 and the ratio u₁/w is greater than 5.

Therefore the formula (I-1-1) encompasses the mono- and diesters of alkyl phosphates (hydrophobic phosphates).

Preferably, the compositions of the invention have a monoester/diester molar ratio of between 1 and 99%.

The present invention also concerns a composition such as defined above in which the surfactant of composition (a) comprises a sulphonic acid or a sulphinic acid of following formula (1-2-1):

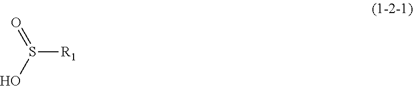

R₁ being such as defined above for formula (II).

One advantageous surfactant of the present invention for composition (a) is characterized in that it comprises:
at least one acid meeting formula (I-1) as defined above, in which n and/or s and/or n′ and/or s′ are different from zero, and advantageously equal to or greater than 3, preferably equal to or greater than 4,
and at least one amine meeting formula (G) such as defined above in which v₁=0 with a u₁/w ratio lower than 5, or the formula (G) such as defined, with v₁ different from 0, Rₐ representing an alkyl group comprising 12 to 14 carbon atoms.

Therefore the preferred surfactants of composition (a) according to the present invention are chosen from among the following salts: XTJ 581 bis (2-ethyl-hexyl)phosphate salts, XTJ 581 dibutylphosphate salts, XTJ 581 paratoluenesulfonate salts, XTJ 581 dodecylbenzenesulfonate salts and XTJ 247 3-phosphonopropyl tetra oxyethylene cetyl ether salts.

The surfactant of composition (a) according to the present invention may comprise a molecule carrying both the amine functions and the acid functions, notably an amino acid with polyether functions.

The present invention also concerns a composition such as defined above, in which the (poly)isocyanate of composition (a) is a (poly)isocyanate chosen from among the products of homo- or hetero-condensation of alkylene-di-isocyanate, notably comprising products of “biuret” type and of “trimer”, even “prepolymer” type with isocyanate function, notably comprising the following functions: urea, urethane, allophanate, ester, amide, acylurea, isocyanurate, oxadiazinetrione, imino-dimer, imino-trimer (iminotriazadione), imino-oxadiazinedione (also called asymmetric trimer), diazetidinedione (also called dimer), and mixtures containing the same.

The polyisocyanate compounds may also comprise true carbamate functions (R—O—C(═O)—NH₂) or epoxy functions or carbonate functions, preferably cyclic.

These may, for example, be polyisocyanates marketed by Rhodia under the trade name “Tolonate®”.

Particular monoisocyanates may be used for the preparation of compositions (a) in order to modulate some properties. As an example of said monoisocyanates, mention may be made of isocyanato propyl trialkoxysilanes.

Other polyisocyanates with NCO functionality greater than 2 may also be used for the preparation of compositions of polyisocyanates (a). The ocyanatoethyl of lysine diisocyanate may be cited which allows reducing of the viscosity of the end polyisocyanate compositions.

It is also possible to use (poly)isocyanates such as defined above and which are made hydrophilic by grafting a suitable hydrophilisation additive.

In general, the preferred (poly)isocyanates are (poly)isocyanates able to be obtained and generally obtained by homo- or hetero-condensation of aliphatic, (cyclo- or aryl-) aliphatic isocyanate monomers, chosen from the group comprising the following monomers: 1,6-hexamethylenediisocyanate (HDI), 1,12-dodecane diisocyanate, cyclobutane-1,3-diisocyanate, cyclohexane-1,3 and/or 1,4-diisocyanate, 1-isocyanato-3,3,5-trimethyl-5-isocyanatomethylcyclohexane (isophorone diisocyanate—IPDI), isocyanatomethyloctylenedi-isocyanate (TTI), dicyclohexyl-methan-4,4′-diisocyanate, toluene diisocyanate (TDI), methylene bis-phenylisocyanate (MDI), 2,2,4-trimethyl-1,6-hexamethylenediisocyanate, 2,4,4-trimethyl-1,6-hexamethylenediisocyanate (TMDI), 2,4- and/or 2,6-hexahydrotoluylene di-isocyanate (H₆TDI), 2,4- and/or 2,6-toluylene diisocyanate, hexahydro-1,3 and/or 1,4-phenylene diisocyanate, 2-methylpentamethylene diisocyanate (MPDI), 1,3- and/or 1,4-phenylene diisocyanate, tetramethylxylilene diisocyanates (TMXDI), triphenylmethane-4,4′,4″-triisocyanate, lysine diisocyanate and esters of lysine di- or tri-isocyanate (LDI or LTI), diphenylmethane-2,4′ and/or 4,4′-diisocyanate (MDI), perhydro 2,4′ and/or 4,4′-diphenylmethane diisocyanate (H₁₂MDI), and in general the aromatic amine precursors or perhydrogenated carbamates, bis-isocyanatomethylcyclohexanes (BIC), notably 1,3-BIC and 1,4-BIC, bis-isocyanatomethylnorbornanes (NBDI) and oligomers of MDI or TDI.

The homo-condensation products are products derived from the condensation of one of the above-listed isocyanate monomers with itself. The products of hetero-condensation are products derived from the condensation of two or more of the above-listed monomers between each other and/or optionally with one or more compounds with mobile hydrogen such as an alcohol, a diol and other similar compounds.

The polyisocyanates comprised in composition (a) may also be derivatives of polyisocyanates derived from aromatic isocyanates used alone or in a mixture with aliphatic compounds.

However, the use of these aromatic derivatives is limited in quantity and is even not preferred since it generally leads to coatings which may become discoloured, generally by yellowing during ageing, in particular if the coatings have strong ultra violet exposure e.g. ultra violet radiation from the sun.

As examples of aromatic isocyanates the following can be cited but are non-limiting:
2,4- and/or 2,6-toluylene di-isocyanate,
diphenylmethane-2,4′ and/or 4,4′-di-isocyanate (MDI),
1,3- and/or 1,4-phenylene di-isocyanate,
triphenylmethane-4,4′,4″-triisocyanate, and oligomers of MDI, or TDI.

Mixtures of these (cyclo)aliphatic and/or aromatic polyisocyanates can also be used.

The viscosity of the non-masked polyisocyanate compounds which can be used in the invention lies within a a very broad range of viscosity on account of the structure of the polyisocyanates compounds which can be used. Viscosity is generally greater than 10 mPa.s at 25° C. at 100% dry extract, preferably greater than 100 mPa.s, at 25° C. and 100% dry extract.

As examples of the viscosity of products manufactured by Rhodia, mention may be made of Tolonate® HDT-LV2 which has a viscosity of the order of 600 mPa.s±150 mPa.s at 25° C., or Tolonate® HDT with a viscosity of 2 400 mPa.s±400 mPa.s at 25° C., or Tolonate® HDB with viscosity of 9 000 mPa.s±2000 mPa.s at 25° C., or Tolonate® HDT HR with viscosity of about 20 000 mPa.s at 25° C. at 100% dry extract, or 2 000 mPa.s at 25° C. at 90% dry extract in n-butyl acetate.

Some polyisocyanate compounds are solids at 100% dry extract. This is the case for example of the isocyanurate trimer of IPDI or IPDI dimer. As an example, the viscosities of some of these compounds can be given in an organic solution; for example Tolonate® IDT 70 S (trimer isocyanurate of IPDI) has a viscosity of the order of 1 700 mPa.s±600 mPa.s at 25° C. for a formulation with 70% dry extract in Solvesso® 100, Tolonate® IDT 70 B (trimer isocyanurate of IPDI) has a viscosity of the order of 600 mPa.s±300 mPa.s at 25° C. for a formulation with 70% dry extract in n-butyl acetate.

According to one particular embodiment, the (poly)isocyanates of composition (a), (b) or (d) may be temporarily and/or definitively masked.

The (poly)isocyanates present in the composition of the invention may be in masked form i.e. the isocyanates functions are not free, but masked using a masking agent or mixture of masking agents, such as defined below.

In the present description, by masked (poly)isocyanate is meant a (poly)isocyanate for which at least 50%, preferably 80%, advantageously 90% and further preferably all the isocyanates functions are masked.

For example, the (poly)isocyanate compounds can be masked temporarily and/or definitively by a compound having at least one function carrying a labile hydrogen.

In this case, the masking agent or mixture of masking agents which temporarily, even definitively protects the isocyanate functions is a compound which has at least one function carrying a labile hydrogen, generally a function carrying a labile hydrogen, preferably a single function carrying a labile hydrogen and which is reactive with respect to the isocyanate function. With this function carrying a labile hydrogen, a value of pKₐ can be associated which corresponds either to ionisation of an acid [including the hydrogen of the -ol functions (in the present description by “-ol(s)” is meant phenols and alcohols)], or to the acid associated with a base (generally nitrogenous).

More precisely, to optimize the results of the present invention, said pKₐ (or one thereof if several can be defined) of the function carrying one or more labile hydrogens is at least equal to 4, advantageously 5, preferably 6 and is no more than 14, advantageously 13, preferably 12, and further preferably 10. An exception must be made however for the lactames, whose pKₐ is higher than these values and which form possible masking agents although not preferred for the invention.

A masking agent is said to be temporary when the isocyanate function is protected temporarily by the masking agent and does not react under the storage conditions of the system formulated with hydroxyl functions of the mobile hydrogen compound notably polyol, but is then released during the oven thermal cross-linking reaction.

The released isocyanate function then reacts with the mobile hydrogen functions or polyol reagent to yield a urethane bond and leads to the polyurethane network which forms part of the coating. The temporary masking agent is either removed as volatile organic compound with most of the solvents of the formulation, or remains in the film, or reacts with the aminoplast resin if contained in the formulation.

As non-limiting examples of temporary masking agents according to the invention, mention may be made of derivatives of hydroxylamine such as hydroxysuccinimide and of oximes such as methylethylcetoxime, the derivatives of hydrazine such as pyrazoles, the derivatives of triazoles, the derivatives of imidazoles, the derivatives of phenols or similar, the derivatives of amides such as imides and lactames, encumbered amines such as N-isopropyl-N-benzylamine, and the malonates or ketoesters and hydroxamates. The compounds may optionally comprise substituents, notably alkyl chains

For the détermination of the pKₐ values defined above, reference may be made to “The determination of ionization constants, a laboratory manual”, A. Albert and E. P. Serjeant; Chapman and Hall Ltd, London”.

For the list of masking agents reference may be made to Z. Wicks (Prog. Org. Chem., 1975, 3, 73 and Prog. Org. Chem., 1989, 9,7) and to Petersen (Justus Liebigs, Annalen der Chemie 562, 205, (1949).

As temporary masking agents preference is given to methylethylketoxime also called MEKO, 3,5-dimethylpyrazole also called DMP, 2 or 4 alkylimidazole, dialkyl malonates, cyclic β-ceto-esters, amines, encumbered amines and caprolactame.

The present invention is not limited to temporary masking agents alone, but may also involve so-called definitive masking agents. These are characterized by the fact that the isocyanate functions are protected by the masking agent and do not react with the hydroxyl functions of the compound with the mobile hydrogen notably the polyol, under the storage conditions of the formulated system, nor during the oven thermal cross-linking reaction.

The isocyanate functions are not restored at the time of the oven cross-linking reaction and remain masked, said masked functions then being able to react under oven cross-linking conditions with the methylol (—N—CH₂—OH) or alkoxyalkyl (—N—CH₂—O—alkyl) functions of the aminoplast resins (melamines, benzoguanamine . . . ), in the presence of an acid catalyst, preferably sulphonic, or a latent precursor of this catalyst which may be a tertiary amine salt of a sulphonic acid.

In some cases, the surfactant present in the composition of the invention may act as catalyst, notably when the surfactant is of anionic type and comprises a phosphorus atom.

The masking agents used to protect definitively the isocyanate function are in general compounds with hydroxyl or sulfhydril functions, preferably monofunctional, such as hydroxy(cyclo)alkanes e.g. methanol, butanols, cyclohexanol, 2-ethylhexanol or compounds with carboxylic acid functions, such as propionic acid, pivalic acid, benzoic acid. These compounds may optionally carry one or more substituents.

These so-called <<definitive>> masking agents may also be isocyanate functions masked by compounds comprising at least one cross-linkable function capable of polymerising under UV radiation. For example, as <<definitive>> masking agents, mention may be made of hydroxyalkyl-acrylates or -methacrylates.

It is also possible in some cases, and in generally limited quantity, to use temporary bi- or poly-functional masking agents, comprising functions capable of giving temporary and/or definitive masked isocyanate functions. However, this is not preferred since masked polyisocyanate compounds rapidly exhibit high viscosities, especially since the isocyanate functionality (NCO) is higher.

The present invention also concerns a composition which can be cross-linked by heat treatment, such as defined above, further comprising at least one compound carrying at least one function with mobile hydrogen chosen from among primary or secondary hydroxyl functions, phenols, primary and/or secondary amines, carboxylic and SH functions, and optionally at least one organic solvent.

Preferably, the composition which can be cross linked by heat treatment such as defined above comprises:
10% to 60% by weight of (poly)isocyanate, relative to the total weight of the composition without solvent (dry %);
0.25% to 12% by weight of surfactant, relative to the total weight of the composition without solvent (dry %);
30% to 80% by weight of compound carrying at least one function with mobile hydrogen, relative to the total weight of the composition without solvent (dry %); and
0% to 30% by weight of organic solvent, relative to the total weight of the composition.

Advantageously, the composition cross-linkable by heat treatment such as defined above may further comprise at least one aminoplastic resin (“aminoplast” resin) of melamine-aldehyde type, in particular melamine-formaldehyde, and/or urea-aldehyde, in particular urea-formaldehyde, or benzoguanamine and/or their alkoxyalkyl derivatives.

According to one preferred embodiment, in the composition cross-linkable by heat treatment such as defined above, the quantity of aminoplast resin(s) lies between 15% and 25% by weight relative to the total weight of the composition without solvent (dry %).

The composition cross-linkable by heat treatment according to the present invention also comprises a resin of aminoplast type of melamine formol and/or urea formol and/or benzoguanamine formol type. These polymers are known and details on their syntheses are proposed in the above-cited works, notably the book by Stoye and Freitag on page 102, chapter 6.2.

These aminoplast resins notably react at a temperature of between 100 and 180° C. with the urethane functions of the polyurethane network, which are previously created or formed during the oven cross-linking reaction by the reaction of released isocyanate functions with the hydroxyl functions of the polyol, or with the true carbamate functions (R—O—C(═O)—NH₂) optionally carried by the polyols or polyisocyanates.

The cross-linking reaction of these melamines with the urethane or true carbamate functions (R—O—C(═O)—NH₂) is a known reaction which is generally catalysed by a strong acid such as para-toluenesulphonic acid or naphtalene-sulphonic acid, or a latent form of these acid catalysts namely the tertiary amine salts of these strong acids. Reference can be made to the books previously cited for more detailed information on these aminoplast resins and their syntheses.

The presence of one or more aminoplast resins in the coating composition of the present invention is particularly advantageous for the formation of the base coat, and is generally not necessary for the formation of the top coat, although this is not excluded from the scope of the invention.

The present invention also concerns a composition cross-linkable by heat treatment such as defined above, in which the compound carrying at least one function with mobile hydrogen is a polymer containing at least two hydroxyl functions (alcohol or phenol) and/or thiol functions and/or primary or secondary amine functions and/or containing carboxylic acid functions and/or containing precursor functions of epoxy or carbonate type which, by reaction with an adequate nucleophil, release the hydroxyl functions.

Preferably the compounds are chosen from among the polyols which can be used alone or in a mixture.

As examples of said compounds it is possible to cite polyols or polyurethanes in dispersion or polyamines or polythiols or polyacids. These polymers may optionally contain a multiplicity of functions with mobile hydrogen. Mixtures of said polymers may also be used. In general, preference is given to polyols chosen from among polyesters, polyacrylates, or polyethers, or mixtures thereof.

For coatings exposed to outdoor conditions, acrylic polyesters or polyols or polyurethane polyols are advantageously chosen.

The polyol compositions which come under the latex denomination may also be used. These compounds are generally obtained by radical polymerisation of compounds with alkenyl functions such as acrylates, methacrylates, styrenyls . . .

Under the present invention, it is also possible to add the acid and amine salt to the compound carrying mobile hydrogen bonds (polyols, polyamines, polycarboxylic acids and polythiols) and then to add the polyisocyanate to the previously prepared mixture.

Further preferably, the composition cross-linkable by heat treatment such as defined above is characterized in that the compound carrying at least one function with mobile hydrogen is a polyol chosen from among acrylic or polyester or polyurethane polyols.

For reasons of flexibility of the coatings, and particularly for the <<primer>> coat it is preferred to use polyester or polyester urethane polyols. In general a mixture of two polyester or urethane polyester resins is used, one being characterized by a <<hard>> nature and the other having a <<soft>> or <<flexible>> nature. The hard or flexible nature of the polyesters is conferred by the type of monomers used during their synthesis.

Therefore <<hard>> polyesters will be obtained by choosing acid or aromatic alcohol monomers and/or cycloaliphatic and/or highly branched. As examples of these types of monomers, phtalic anhydride may be cited or cyclohexane-diol or 2,2,4-trimethylpentanediol.

A <<flexible>> polyester is obtained by choosing scarcely branched straight aliphatic monomers, such as adipic acid or 1,4-butanediol or 1,6-hexanediol, or they may contain heteroatoms in their structure, such as di- or polyethylene glycols. The latter are not preferred however insofar as these compounds exhibit weakness with respect to their stability against ultraviolet radiation.

Polyester polyols are industrial and their synthesis is largely described and known to persons skilled in the art. For further details, reference can be made to the following works: <<Polymer materials, structure, properties and applications>> by Gottfried W. Ehrenstein and Fabienne Montagne published in 2000 by Hermès Science; <<Handbook of Polyurethanes>> by Michael Szycher, published in 1999 by CRC Press; <<Resins for coatings, Chemistry, Properties and Applications>> by D. Stoye and W. Freitag, published by Hanser in 1996, and the aEurocoat 97 article previously cited. It is also possible to consult the sales catalogues of polyol distributor companies notably the work titled <<Specialty Resins, creating the solution together>> by AKZO NOBEL RESINS published in February 2001.

Advantageously, the polyol such as defined above has a functionality of groups with mobile hydrogen of at least 2, generally between 2 and 100 and preferably 2 to 30.

According to another advantageous embodiment, the polyol has a OH functionality of between 2 and 25 and preferably 2 and 10.

In general, for the intended application (coating) an OH functionality that is too high would lead to compounds that are too “hard”. It is therefore preferred to use polyester polyols of relatively low functionality of less than 15, preferably less than 10.

The definition of mean hydroxyl functionality per polymer chain is given for example in the article by Ben Van Leeuwen <<High solids hydroxy acrylics and tightly controlled molecular weight>> published in the proceedings of the Eurocaot 1997 conference (pp 505-515) page 507.

This mean functionality F(OH) is calculated using the following equation:

$$F ( OH ) = \frac{OH Number \times Mn}{56100}$$

in which:
F(OH) represents the mean hydroxyl functionality;
OH number represents the content of hydroxyl functions expressed in mg of KOH (potassium hydroxide) per gram of polymer; and
Mn represents the number average molecular weight of the polymer, itself determined by gel permeation chromatography, (GPC) by comparison with calibrated polystyrene standards.

The present invention also concerns a composition cross-linkable by heat treatment such as defined above, characterized in that the number average molecular weight of the compound carrying at least one function with mobile hydrogen lies between 100 and 100 000.

According to one preferred embodiment, the composition cross-linkable by heat treatment such as defined above comprises a polyol which is a polyester polyol with number average molecular weight of between 500 and 10 000, preferably 600 to 4 000.

In some cases it is also possible to use a polyol or mixture of polyacrylic polyols which impart higher hardness to the coating. These polyols can be <<hard>> or <<soft>> depending on whether monomers are used that are respectively aromatic and/or cycloaliphatic and/or strongly branched for this <<hard>> property, or monomers chiefly having an aliphatic nature for the <<soft>> property.

The synthesis of acrylic polyols is also known to those skilled in the art and reference may be made to the works previously cited for further details on their synthesis.

The number average molecular weight for acrylic polyols generally lies between 134 and 50 000, preferably between 500 and 25 000, advantageously between 1 000 and 15 000.

The content of hydroxyl functions generally lies between 10 and 750 mg of KOH per gram of polymer, preferably between 15 and 500 mg of KOH per gram of polymer.

As examples of acrylic polyols, reference can be made to the previously cited Eurocat 97 article, page 515, in which the characteristics of some acrylic polyols are given, these examples being non-limiting.

It is also possible to use hyper-branched polyols which are generally characterized by a higher functionality than straight polyols, but these products are not preferred having regard to the high viscosity of these products.

Structured or block polyols can also be used if a property compartmenting effect is sought. However these products, generally more costly, are only used to provide a particular property. These compounds are for example a rheology agent, or an agent contributing towards pigment dispersion.

As a general rule, for the needs of the present invention, the ratio of isocyanate functions/mobile hydrogen functions lies between 1.5 and 0.5, preferably between 1.2 and 0.8. In particular, when the mobile hydrogen compound is a polyol, the ratio of isocyanate functions/hydroxyl functions lies between 1.5 and 0.5, preferably between 1.2 and 0.8.

The present invention also concerns a method to manufacture a coated substrate, characterized in that it comprises a step to apply to a substrate a cross-linkable composition by heat treatment such as defined above, and a cross-linking step of said composition by heat treatment.

According to one advantageous embodiment, the method such as defined above is characterized in that cross linking is conducted at a temperature of more than 0° C. and preferably close to ambient temperature and advantageously by heat treatment at a temperature of between 60° C. and 300° C., preferably higher than 80° C. and lower than b 300° C., advantageously at between 100° C. and 200° C., for a time of a few seconds to a few hours.

The above-mentioned cross-linkable composition can be used as first layer (application of original coating) or as secondary layer notably for hardening of primer layers, or for refinishing operations.

The present invention also concerns a coated substrate which can be obtained using the method such as defined above.

The present invention also concerns a paint or varnish comprising the cross-linked product of a cross linkable composition by heat treatment such as defined above.

The substrate may be of any type, and is generally a metal substrate e.g. aluminium or steel, in particular stainless steel. The substrate may also be a substrate in plastic material i.e. a thermoplastic or thermo-setting polymer material optionally containing fillers e.g. strengthening fillers for example glass fibres, carbon fibres and others.

By means of the properties imparted by the above-mentioned coating, the coated substrate can then applicable be bent, formed, stamped. The coated substrate has excellent resistance to gritting, and excellent resistance to pressure washing even high-pressure washing, notably substrates in plastic material.

Other adjuvants can be added to the coating formulations notably to facilitate use thereof or to provide a protective or cosmetic function. In this respect, mention may be made of anti-foaming agents, pigments or dyes or additives imparting scratch or tag resistance. This type of addition is well known to persons skilled in the art or to coating formulators who will be able to adjust the quantities to the intended properties of the application.

The fields of application of the novel compounds are adhesives, paints and varnishes, glues, treatment products for textiles or mineral or organic or organic-mineral fibres, concrete or fronting. The substrates to be coated that are concerned are wood, metals, textiles, various celluloses, mineral compounds, glass.

### EXAMPLES

### Examples 1 to 15

### Products

Tests were conducted with three dispersions of commercial polyurethane intended for wood flooring applications:
Reference Best 90 by AKZO Synteko (Resin (1))
Reference Flow by BONA (Resin (2))
Reference Intensiv by Blanchon (Resin (3))

The hydrophilic isocyanate recommended for cross-linking is VPLS 2336® (or Bayhydur)305® (Bayer).

The isocyanates used are the following, at the same dilution (70% dry extract) in dipropyleneglycoldimethylether (DMM, Dow):
Bayhydur VPLS 2336° by Bayer—viscosity 6 325 mPas at 23° C.; content of NCO functions=16.8% (trimer allophanate hydrophilised by an ethylene oxide chain notably described in U.S. Pat. Nos. 6,20,478 and 6,426,414) (for composition (A)).
Rhodocoat X EZ-M 502® by Rhodia—viscosity=3 600 mPa.s at 25° C.; content of NCO functions=18.4% (HDI-based hydrophilic polyisocyanate and comprising isocyanurate functions) (for composition (b)).

### METHOD

The proportion of mixture between the part comprising the polyurethane dispersions and hydrophilic isocyanate is 10 g per 1 g.

The two parts, polyurethane dispersion and isocyanate, are mixed by stirring with a spatula and the ease of dispersion is evaluated using 4 criteria. The first (A) is the time needed to obtain a good dispersion. The three other criteria (B,C,D) are scored on a scale of 0 to 5 (0 being the best and 5 the worst).
A=time needed to obtain a homogeneous mixture
B=presence of aggregates in the dispersion
C=presence of filaments in the dispersion
D=re-deposit after 10 minutes

In parallel, the mixtures are applied to a glass plate using a gauge (wet thickness=200 μm) and the shine is measured after 7 days' drying in a controlled atmosphere (23° C., 50% EH).

### Results With Resin (I)

### Application

| | Description | A | | B | C | D |
|---|---|---|---|---|---|---|
| Example 1 | 100% X EZ-M 502 | <30 | s | 0 | 0 | 0 |
| comparative | | | | | | |
| Example 2 | 75% X EZ-M 502/ | 1 | min | 5 | 0 | 0 |
| | 25% VPLS 2336 | | | | | |
| Example 3 | 50% X EZ-M 502/ | 2 | min | 5 | 0 | 0 |
| | 50% VPLS 2336 | | | | | |
| Example 4 | 25% X EZ-M 502/ | 2 | min | 5 | 0 | 0 |
| | 75% VPLS 2336 | | | | | |
| Example 5 | 100% VPLS 2336 | 3 | min | 5 | 0 | 0 |
| comparative | | | | | | |

The use of Bayhydur VPLS 2336 translates as the presence of aggregates which disappear provided agitation is sufficient. The incorporation of Rhodocoat X EZ-M 502® allows a reduction in the time needed to obtain a good dispersion of the polyisocyanate in the polyurethane dispersion.

### Film Appearance

| | | | Film |
|---|---|---|---|
| | Description | Shine 20° | appearance |
| Example 1 | 100% X EZ-M 502 | 8 | Matt, small |
| comparative | | | homogeneous |
| | | | defects |
| Example 2 | 75% X EZ-M 502/ | 42 | Matt |
| | 25% VPLS 2336 | | |
| Example 3 | 50% X EZ-M 502/ | 80 | Shiny |
| | 50% VPLS 2336 | | |
| Example 4 | 25% X EZ-M 502/ | 80 | Shiny |
| | 75% VPLS 2336 | | |
| Example 5 | 100% VPLS 2336 | 80 | Shiny |
| comparative | | | |

Bayhydur VPLS 2336 alone does not allow a film to be obtained having a good appearance, under these conditions. The addition of 50% Rhodocoat X EZ-M 502® to Bayhydur VPLS 2336® substantially improves the ease of mixing, maintaining a good film appearance.

### Results With Resin (2)

### Application

| | Description | A | | B | C | D |
|---|---|---|---|---|---|---|
| Example 6 | 100% X EZ-M 502 | 15 | s | 0 | 0 | 0 |
| comparative | | | | | | |
| Example 7 | 75% X EZ-M 502/ | 1 | min | 5 | 0 | 0 |
| | 25% VPLS 2336 | | | | | |
| Example 8 | 50% X EZ-M 502/ | 2 | min | 5 | 0 | 0 |
| | 50% VPLS 2336 | | | | | |
| Example 9 | 25% X EZ-M 502/ | 3 | min | 5 | 0 | 0 |
| | 75% VPLS 2336 | | | | | |
| Example 10 | 100% VPLS 2336 | 3 | min | 5 | 2 | 0 |
| comparative | | | | | | |

### Film Appearance

| | | Shine | |
|---|---|---|---|
| | Description | 20° | Film appearance |
| Example 6 | 100% X EZ-M 502 | 18 | Presence of |
| comparative | | | pitting, particles |
| Example 7 | 75% X EZ-M 502/ | 90 | Shiny appearance, |
| | 25% VPLS 2336 | | some particles |
| Example 8 | 50% X EZ-M 502/ | 98 | Shiny |
| | 50% VPLS 2336 | | |
| Example 9 | 25% X EZ-M 502/ | 100 | Shiny |
| | 75% VPLS 2336 | | |
| Example 10 | 100% VPLS 2336 | 100 | Shiny |
| comparative | | | |

The addition of Rhodocoat X EZ-M 502® to Bayhydur VPLS 2336® here again allows a substantial improvement in ease of mixing, whilst maintaining a good appearance of the film

### Results With Resin (3)

### Application

| | Description | A | | B | C | D |
|---|---|---|---|---|---|---|
| Example 11 | 100% X EZ-M 502 | <15 | s | 0 | 0 | 0 |
| comparative | | | | | | |
| Example 12 | 75% X EZ-M 502/ | 50 | s | 4 | 0 | 0 |
| | 25% VPLS 2336 | | | | | |
| Example 13 | 50% X EZ-M 502/ | 2 | min | 4 | 0 | 0 |
| | 50% VPLS 2336 | | | | | |
| Example 14 | 25% X EZ-M 502/ | 2 | min | 5 | 0 | 0 |
| | 75% VPLS 2336 | | | | | |
| Example 15 | 100% VPLS 2336 | 2 | min | 5 | 0 | 0 |

comparative

### Film Appearance

| | | Shine | |
|---|---|---|---|
| | Description | 20° | Film appearance |
| Example 11 | 100% X EZ-M 502 | 7 | Opaque |
| comparative | | | |
| Example 12 | 75% X EZ-M 502/ | 90 | Shiny appearance, |
| | 25% VPLS 2336 | | some pitting |
| Example 13 | 50% X EZ-M 502/ | 95 | Shiny |
| | 50% VPLS 2336 | | |
| Example 14 | 25% X EZ-M 502/ | 99 | Shiny |
| | 75% VPLS 2336 | | |
| Example 15 | 100% VPLS 2336 | 98 | Shiny |
| comparative | | | |

The addition of Rhodocoat X EZ-M 502® to Bayhydur VPLS 2336® once again provides a substantial improvement in ease of mixing, whilst maintaining a good film appearance.

### Examples 16 to 19

### Products

Hydrophilic polyisocyanate A resulting from the addition of a polyoxyethylene amine (XTJ 581 by Huntsmann) to Tolonate (Rhodia) HDT (% NCO=21.8%, viscosity=2000 mPa.s at 25° C.)
   90 g of Tolonate HDT and 10 g of XTJ 581 are mixed at 50° C. in a glass reactor. After 30 minutes, the reaction is halted and the measured content of NCO gives the expected theoretical value i.e. 19%. (composition (A) with a chain of urea type).
X EZ-M 502® by Rhodia—viscosity=3 600 mPa.s at 25° C.; content of NCO functions=18.4% (HDI-based hydrophilic polyisocyanate and comprising isocyanurate functions) (for composition (b)).

### Results With Resin (2)

### Application

| | Description | A | B | C | D |
|---|---|---|---|---|---|
| Example 16 | 75% X EZ-M 502/ | 15 s | 0 | 0 | 0 |
| | 25% polyisocyanate A | | | | |
| Example 17 | 50% X EZ-M 502/ | 15 s | 0 | 5 | 0 |
| | 50% polyisocyanate A | | | | |
| Example 18 | 25% X EZ-M 502/ | 15 s | 0 | 5 | 0 |
| | 75% polyisocyanate A | | | | |
| Example 19 | 100% polyisocyanate A | 15 s | 0 | 5 | 0 |
| comparative | | | | | |

The mixing time is identical for all the products, but this is only apparent since without the addition of Rhodocoat X EZ-M 502® the precipitation of particles is quickly observed, a sign of the presence of particles of large diameter.

### Film Appearance

| | | Shine | |
|---|---|---|---|
| | Description | 60° | Film appearance |
| Example 16 | 75% X EZ-M 502/ | 62 | Shiny appearance |
| | 25% polyisocyanate A | | some pitting |
| Example 17 | 50% X EZ-M 502/ | 41 | Mat |
| | 50% polyisocyanate A | | |
| Example 18 | 25% X EZ-M 502/ | 35 | Mat |
| | 75% polyisocyanate A | | |
| Example 19 | 100% polyisocyanate A | 28 | Mat |
| comparative | | | |

The addition of Rhodocoat X EZ-M 502® allows a stable dispersion to be obtained, while maintaining acceptable visual appearance.

1. Composition of polyisocyanates comprising:
A) a composition of hydrophilic polyisocyanates, consisting of at least one hydrophilic (poly)isocyanate, comprising an isocyanate part and a hydrophilic group, said hydrophilic group being of monofunctional polyoxyalkylene type and being attached to the isocyanate part via a function containing a chain of formula 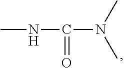
and
B) a composition of polyisocyanates consisting of:
a) either a composition consisting of a mixture of at least one (poly)isocyanate with at least one compound having an ionic function,
said mixture being characterized in that it comprises 2% to 15% of said compound and 50% to 98% of (poly)isocyanate,
b) or a composition consisting of at least one (poly)isocyanate comprising at least one bonded ionic function,
c) or a composition consisting of a mixture of a composition (a) and a composition (b),
d) or a composition consisting of at least one (poly)isocyanate comprising at least one urethane function carrying at least one monofunctional polyoxyalkylene chain, said alkyl group comprising 1 to 30 carbon atoms, in association with a composition (a), (b) or (c).

2. The composition of polyisocyanates according to claim 1, wherein the composition of polyisocyanates (A) has:
a mean NCO functionality of at least 2,
a content of isocyanate NCO groups of 5% to 25% by weight, and
a content of ethylene oxide units of 2% to 50%, by weight, said ethylene oxide units being incorporated in polyether chains containing an average of 5 to 35 ethylene oxide units, said composition (A) being characterized in that at least 60 mole % of the polyether chains are attached via urea or allophanate or biuret or acylurea groups to two molecules of diisocyanates or polyisocyanates.

3. The composition of polyisocyanates according to any of claims 1 or 2, wherein the composition of polyisocyanates (b) has:
a mean NCO functionality of at least 2;
a content of isocyanate NCO groups of 5% to 25% by weight;
a mole content of ionic functions per 100 g of composition (b) of between 10⁻⁵ to 1;
a content of ethylene oxide units of 0% to 19.5%, by weight, said ethylene oxide units being incorporated in polyether chains containing an average of 5 to 55 ethylene oxide units.

4. The composition of polyisocyanates according to any of claims 1 or 2, wherein the (poly)isocyanate comprising at least one urethane function carrying at least one monofunctional polyoxyalkylene chain of composition (d) has:
a mean NCO functionality of at least 2;
a content of isocyanate NCO groups of 5% to 25% by weight; and
a content of ethylene oxide units of 2% to 50% by weight, said ethylene oxide units being incorporated in polyether chains containing an average of 5 to 35 ethylene oxide units.

5. The composition according to claim 1 or 2, wherein said composition comprises:
from 20% to 80% by weight of composition (A), and
20% to 80% by weight of composition (a).

6. The composition according to any of claims 1 or 2 wherein the compound having an ionic function of composition (a) is a surfactant comprising an acid meeting following formula (I): 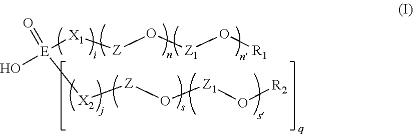
in which:
E represents phosphorus or carbon,
Z and Z₁ each independently represent a bivalent alkylene radical, straight or branched consisting of 2 to 10, carbon atoms, Z and Z₁ possibly being the same or different, these alkylene units possibly being linked random fashion or in ordered blocks,
R₁ and R₂, the same or different, each independently represent H or a hydrocarbon chain, straight or branched or (hetero)cyclic, and optionally substituted by at least one halogen, notably a fluorine,
X₁ and X₂, the same or different each independently represent S, O, N(R), R representing H, an alkyl group comprising 1 to 20 carbon atoms, a hydrocarbon bond or chain, optionally containing at least one heteroatom, attached to R₁ or R₂ to form a bivalent alkylene radical, straight or branched, optionally substituted, comprising 2 to 30 carbon atoms, and optionally containing at least one heteroatom or, when E represents a phosphorus atom, X₁ and/or X₂ may represent —O—[P(═O)-(A)]ᵥ-(O)ᵤ—, where:
A represents OH, —O—[(Z—O)ₙ—(Z₁—O)_{n′}]—R₁, [(Z—O)ₙ—(Z₁—O)_{n′}—]R₁, —O—[(Z—O)ₛ—(Z₁—O)_{s′}]—R₂ or [—(Z—O)ₛ—(Z₁—O)_{s′}]—R₂, Z, Z₁, R₁ and R₂ being such as defined above,
v is an integer of between 1 to 6,
u is an integer of 0 or 1,
i and j each independently represent 0 or 1;
n and n′ each independently represent zero or an integer of between 1 to 30;
q represents zero or 1; and
s and s′ each independently represent zero or an integer of between 1 to 30; on the understanding that when E is C, then q equals zero, and when E is C and X₁ is equal to the oxygen atom, then R₁ is advantageously different from H.

7. The composition according to claim 1 wherein the (poly)isocyanate of composition (a) is a (poly)isocyanate chosen from among the products of homo- or hetero-condensation of alkylene-di-isocyanate.

8. The composition according to claim 1, further comprising at least one compound carrying at least one function with mobile hydrogen chosen from among the primary or secondary hydroxyl functions, phenols, primary and/or secondary amines, carboxylic and SH function, and optionally at least one organic solvent.

9. The composition according to claim 8, wherein the compound carrying at least one function with mobile hydrogen is a polymer containing at least two hydroxyl functions (alcohol or phenol) and/or thiol functions and/or primary or secondary amine functions and/or containing precursor functions of epoxy or carbonate type which, by reaction with an adequate nucleophil, release the hydroxyl functions.

10. The composition according to claim 8, wherein the compound carrying at least one function with mobile hydrogen is a polyol chosen from among acrylic or polyester or polyurethane polyols.

11. The composition according to claim 10, wherein the number average molecular weight of the compound carrying at least one function with mobile hydrogen lies between 100 and 100,000, when the compound carrying at least one function with mobile hydrogen is a polyester polyol and from 1,000 to 15,000 when the compound carrying at least one function with mobile hydrogen is an acrylic polyol.

12. Method to manufacture a coated substrate comprising a step to apply to a substrate a composition according to claim 8, and a cross-linking step by heat treatment of said composition, said cross-linking step by heat treatment being conducted at a temperature of between 60° C. and 300° C. for a time of a few seconds to a few hours.

13. The composition according to claim 7, wherein the (poly)isocyanate of composition (a) is a (poly)isocyanate chosen from among the products of homo- or hetero-condensation of alkylene-di-isocyanate, notably comprising the functions urea, urethane, callophanate, ester, amide, acylurea, isocyanurate, oxadiazinetrione, imino-dimer, imino-trimer, imino-oxadiazinedione, diazetidinedione, and from among mixtures containing the same.

14. The composition according to claim 1, wherein the (poly)isocyanate of composition (a) is a (poly)isocyanate able to be obtained and generally obtained by homo- or hetero-condensation of aliphatic (cyclo- or aryl-) aliphatic isocyanate monomers, chosen from the group consisting of the following monomers: 1,6-hexamethylenediisocyanate, 1,12-dodecane diisocyanate, cyclobutane-1,3-diisocyanate, cyclohexane-1,3 and/or 1,4-diisocyanate, 1-isocyanato-3,3,5-trimethyl-5-isocyanatomethylcyclo-hexane, isocyanatomethyloctylenedi-isocyanates, dicyclohexyl-methan-4,4′-diisocyanate, toluene diisocyanate, methylene bis-phenylisocyanate, 2,2,4-trimethyl-1,6-hexamethylene-diisocyanate, 2,4,4-trimethyl-1,6-hexamethylenediisocyanate, 2,4- and/or 2,6-hexahydrotoluylene di-isocyanate, 2,4- and/or 2,6-toluylene diisocyanate, hexahydro-1,3 and/or 1,4-phenylene diisocyanate, 2-methylpentamethyléne diisocyanate, 1,3- and/or 1,4-phenylene diisocyanate, tetramethylxylilene diisocyanates, triphenylmethane-4,4′,4″-triisocyanate, lysine diisocyanate and esters of lysine di- ou tri-isocyanate, diphenylmethane-2,4′ and/or 4,4′-diisocyanate, perhydro 2,4′ and/or 4,4′-diphenylmethane diisocyanate, and in general the aromatic amine precursors or perhydrogenated carbamates, bis-isocyanatomethylcyclohexanes, notably 1,3-BIC and 1,4-BIC, bis-isocyanatomethylnorbornanes and oligomers of methylene bis-phenylisocyanate or of toluene diisocyanate.

15. Method to manufacture a coated substrate, comprising a step to apply to a substrate a composition according to claim 9, and a cross-linking step by heat treatment of said composition, said cross-linking step by heat treatment being conducted at a temperature of between 60° C. and 300° C. for a time of a few seconds to a few hours.

16. Method to manufacture a coated substrate, comprising a step to apply to a substrate a composition according to claim 10, and a cross-linking step by heat treatment of said composition, said cross-linking step by heat treatment being conducted at a temperature of between 60° C. and 300° C. for a time of a few seconds to a few hours.

17. Method to manufacture a coated substrate, comprising a step to apply to a substrate a composition according to claim 11, and a cross-linking step by heat treatment of said composition, said cross-linking step by heat treatment being conducted at a temperature of between 60° C. and 300° C. for a time of a few seconds to a few hours.
